(19) United States
(12) Patent Application Publication
(10) Pub. No.: US 2004/0185284 A1
(43) Pub. Date: Sep. 23, 2004

(54) Ultrathin charge dissipation coatings

(75) Inventors: Peter Kian-Hoon Ho, Cambridge (GB); Victor Alexander Lifton, Bridgewater, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ

(21) Appl. No.: 10/391,320

(22) Filed: Mar. 18, 2003

(51) Int. Cl. B05D 5/12

(52) U.S. Cl. 428/500; 427/58; 428/446

(57) ABSTRACT

Apparatus comprising a first polymer layer carrying positively charged moieties and a net positive charge; a second polymer layer carrying negatively charged moieties and a net negative charge; and a dielectric substrate; the first and second polymer layers constituting a multilayer coating on the dielectric substrate. Method for fabrication of an electrostatic charge dissipation coating comprising steps of providing a dielectric substrate susceptible to electrostatic charge accumulation; coating the dielectric substrate with a first polymer carrying charged moieties and a net charge having a first sign; and then coating the dielectric substrate with a second polymer carrying charged moieties and a net charge having a second sign opposite to the first sign.

### FIELD OF THE INVENTION

The present invention generally relates to electrostatic charge dissipation coatings that are suitable for use in microelectronic devices having dielectric substrates. The present invention also relates to processes for applying such coatings, and to the resulting products.

### BACKGROUND OF THE INVENTION

Microelectronic devices are generally fabricated on dielectric substrates, the purpose of such substrates being to provide a stable support for the devices and also to provide insulation for the electronic circuitry. Herein, the term “dielectric substrate” includes both dielectric coatings on supporting substrates of any desired construction, and substrates that are themselves made from dielectric materials. Dielectric in this context means that the dielectric coating or dielectric material acts as an electrical insulator and thus is capable of accumulating an electrostatic charge.

Electrostatic charges can distort and degrade the intended performance of electronic circuitry. For example, micro-electro-mechanical systems (MEMS) may include microscopic movable components such as mirrors, the movements of which are controlled by charges on electrodes in the vicinity of the mirrors. A static electric charge in a dielectric substrate will affect the mirror position, thereby interfering with the control of the MEMS device by the electrodes. Static charges in the dielectric substrate can create electric fields that reach several hundred kiloVolts per centimeter (kV/cm) and lead to a complex and time dependent distortion of mirror movement. This distortion degrades the performance of the exemplary electrostatically controlled MEMS device. Analogous degradation can occur in other types of microelectronic devices.

Efforts have previously been made to facilitate dissipation of static electric charges in microelectronic devices. For example, layered electrostatic discharge coatings have been applied onto dielectric device substrates by depositing layers containing varied concentrations of silicon based dopants such as silicon carbide, silicon oxide, and silicon nitride. The thickness of the resulting coatings is on the order of several hundred angstroms (Å). Unfortunately, a static charge dissipation coating thickness of several hundred A can be too thick for practical use because it can desensitize the device to the intended operation of the electronic circuit or otherwise interfere with fabrication of the microelectronic device. Other electrostatic charge dissipation coatings, such as sub-percolation conductive composites, are characterized by non-ohmic current and voltage characteristics that cause excessive levels of parasitic power dissipation and result in difficulty with control of the device performance. Furthermore, the deposition of such composite layers necessitates inconvenient processing steps including photolithography and liftoff or back-etching and results in additional compatibility challenges depending on the substrate and intended end-use application.

Accordingly, there is a need for improved electrostatic charge dissipation coatings for microelectronic devices having dielectric substrates. Such coatings need to provide effective dissipation of electrostatic charges that accumulate in the dielectric substrates, while facilitating the intended operation of the electronic circuitry without causing excessive parasitic power dissipation.

Polyelectrolytes are one class of polymers that carry charged moieties. Polyelectrolytes can be deposited onto a substrate according to a previously discovered layer-by-layer process. Background information is provided in the following references, the entirety of which are herein incorporated by reference: G. Decher and J. D. Hong, Ber. Der Bunsen-Gesellschaft-Phys. Chem. Chem. Phys. 95, 1430-1434 (1991); G. Decher, J. D. Hong, and J. Schmitt, Thin Solid Films 210, 831-835 (1992); and G. Decher, Science 277, 1232-1237 (1997). The layer-by-layer process has been applied to conductive and electroactive films. Background information is provided in the following references, the entirety of which are herein incorporated by reference: J. H. Cheung, A. F. Fou, and M. F. Rubner, Thin Solid Films 244, 985-989 (1994); and A. C. Fou and M. F. Rubner, Macromolecules 28, 7115-7120 (1995). However, this work regarding conductive and electroactive films was based on unstable in-situ film growth processes.

Furthermore, electronically-conductive polyelectrolyte coatings utilizing functionalized polythiophenes have been described in J. Lukkari, M. Salomaki, A.Viinikanoja, T. Aaritalo, J. Paukkunen, N. Kocharova, and J. Kankare, Polyelectrolyte Multilayers from Water-Soluble Poly (Alkoxythiophene) Derivatives, J. Am. Chem. Soc. 2001, 123, pp. 6083-6091, the entirety of which is hereby incorporated herein by reference. However, the conductivity of films produced according to the teachings of this reference was more than an order of magnitude too high for practical use in surface electrostatic charge dissipation for integrated circuit elements. Such films also were not likely to have the requisite electrical or environmental stability.

The preparation of stable high-performance interfacial films using polyelectrolyte assembly has also been demonstrated. Background information is provided in the following references, the entirety of which are herein incorporated by reference: P. K. H. Ho, M. Granström, R. H. Friend, and N. C. Greenham, Adv. Mater. 10, 769-774 (1998); and P. K. H. Ho, J. S. Kim, J. H. Burroughes, H. Becker, S. F. Y. Li, T. M. Brown, F. Cacialli, and R. H. Friend, Nature 404, 481-484 (2000). As disclosed in these references, poly(3,4-ethylenedioxythiophene) complexed with poly(styrenesulfonate), can be used to produce a ternary composite system for incorporation in graded injection layers. However, such references do not address the fabrication of lateral charge dissipation layers or indeed indicate whether such layers could be tuned to the low direct current (DC) conductivity and stability required for operation with strong electric fields.

### SUMMARY OF THE INVENTION

In one embodiment according to the present invention, an apparatus is provided comprising: a first polymer layer carrying positively charged moieties and a net positive charge; a second polymer layer carrying negatively charged moieties and a net negative charge; and a dielectric substrate; said first and second polymer layers constituting a multilayer coating on said dielectric substrate. In another embodiment according to the present invention, the apparatus comprises a primer layer chemically bonded to said dielectric substrate and electrostatically bonded to said multilayer coating. In yet a further embodiment according to the present invention, the apparatus comprises: a third polymer layer carrying positively charged moieties and a net positive charge; and a fourth polymer layer carrying negatively charged moieties and a net negative charge; said first, second, third and fourth polymer layers being arranged in a multilayer coating having mutually alternating net charges on said dielectric substrate. In still another embodiment according to the present invention, at least one of said polymer layers comprises a polyelectrolyte. In yet another embodiment according to the present invention, the coating has a sheet resistivity between about 0.01 gigaOhms per square and about 100,000 gigaOhms per square.

In a further embodiment according to the present invention, a method for fabrication of an electrostatic charge dissipation coating is provided, comprising steps of: providing a dielectric substrate susceptible to electrostatic charge accumulation; coating said dielectric substrate with a first polymer carrying charged moieties and a net charge having a first sign; and then coating said dielectric substrate with a second polymer carrying charged moieties and a net charge having a second sign opposite to said first sign. In another embodiment according to the present invention, the method comprises coating said dielectric substrate with a primer layer before performing the step of coating said dielectric substrate with a first polymer, the primer layer capable of bonding to said dielectric substrate and having moieties carrying charges of said second sign. In yet a further embodiment according to the present invention, the method comprises then coating said dielectric substrate with a third polymer carrying charged moieties and a net charge having said first sign; and then coating said dielectric substrate with a fourth polymer carrying charged moieties and a net charge having said second sign.

A more complete understanding of the present invention, as well as further features and advantages of the invention, will be apparent from the following detailed description and the accompanying drawings.

### BRIEF DESCRIPTION OF THE DRAWINGS

FIG. 1 is a cross-sectional view of a dielectric substrate having a multilayer electrostatic charge dissipation coating in accordance with the present invention;

FIGS. 2, 3 and 4 each are cross-sectional views of a dielectric substrate provided with electrical circuitry and having a multilayer electrostatic charge dissipation coating in accordance with the present invention;

FIG. 5 is a cross-sectional conceptual diagram of the chemical structures of the components of a multilayer electrostatic charge dissipation coating in accordance with the present invention;

FIG. 6 is a flow chart of an exemplary method for preparation of an electrostatic charge dissipation coating in accordance with the present invention;

FIG. 7 is a scatter plot of electrode column positions versus electrode conductivity ranking for an exemplary multilayer electrostatic charge dissipation coating in accordance with the present invention;

FIG. 8 is a histogram plot illustrating low-field electrical conductivity of an exemplary multilayer electrostatic charge dissipation coating in accordance with the present invention at various stages of its preparation and of its incorporation into a microelectronic device;

FIG. 9 shows current as a function of time across a 2 micrometer—wide and 1 millimeter—long electrode gap held at a fixed electrode bias of 100 volts (V), illustrating the stability over time of charge dissipation of an exemplary multilayer electrostatic charge dissipation coating in accordance with the present invention; and

FIG. 10 shows the current (I)—voltage (V) characteristics of the same gap as in FIG. 9, thereby illustrating the ohmic characteristics of the exemplary multilayer electrostatic charge dissipation coating in accordance with the present invention.

In the figures and text, the reference numbers refer to elements with similar functional properties.

### DETAILED DESCRIPTION

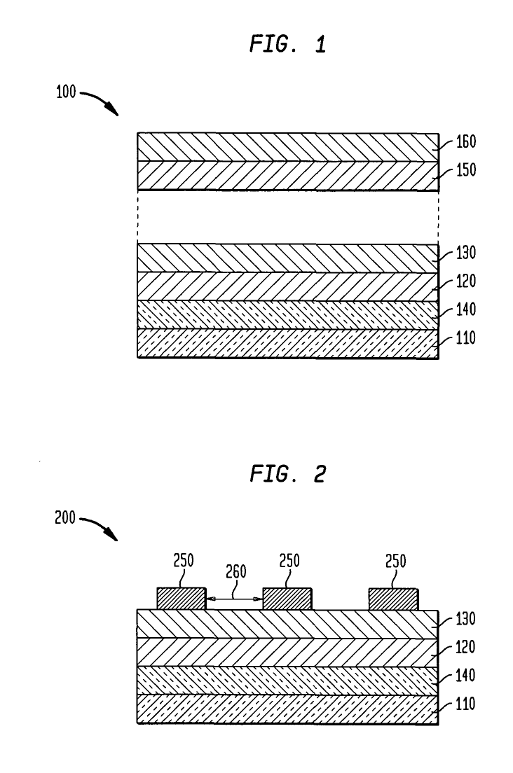

Referring to FIG. 1, a cross sectional illustration is provided of an embodiment 100 of an electrostatic charge dissipation coating in accordance with the present invention, for a microelectronic device having a dielectric substrate. FIG. 1 shows a portion of the dielectric substrate 110 of such a microelectronic device. A multilayer coating overlays the dielectric substrate 110, and comprises layers 120 and 130. One of coating layers 120 and 130 comprises a polymer comprising positively charged moieties and carrying a net positive charge; and the other of coating layers 120 and 130 comprises a polymer comprising negatively charged moieties and carrying a net negative charge. The opposing net charges in the respective polymers included in layers 120 and 130 provide a strong electrostatic bond between them, while preserving a high density of charged moieties. One or both of layers 120 and 130 includes an electronically-conductive polymer which can be, for example, an ionomer or a polyelectrolyte.

The electronically-conductive polymer renders the multilayer coating useful for dissipating any electrostatic charge buildup in the adjacent dielectric substrate 110. The choice as to the net charge sign of the first deposited layer 120 is discretionary, that is, its net charge sign can be either positive or negative. The strong electrostatic bonds maintain layers 120 and 130 adhered together without peeling. In the absence of such electrostatic bonds, interlayer bonds having inadequate strength for device applications may result. The electrostatic bonding between layers 120 and 130 is generated by virtue of their oppositely-charged moieties. Potentially, layers 120 and 130 could additionally be bonded together by other forms of bonds, such as covalent bonds, but such other bonding is not essential.

In one preferred embodiment according to the present invention, a primer layer 140 including moieties carrying a positive or negative charge and accordingly providing the primer layer with a net positive or negative charge is interposed between the dielectric substrate 110 and the first-deposited coating layer 120. The purpose of the primer layer 140 is to provide a charged surface that is firmly bonded to the dielectric substrate 110, onto which oppositely charged coating layer 120 may be electrostatically bonded. For example, the primer layer 140 may comprise a monomer or polymer that covalently or ionically bonds to the dielectric substrate 110, thereby providing a firmly attached foundation for deposition of a charged, electrostatically bonded coating layer 120. Although FIG. 1 shows a simple embodiment comprising two oppositely charged coating layers 120 and 130 and a preferred primer layer 140, further oppositely charged coating layers represented by coating layers 150 and 160 may be added with alternating positive and negative charges as desired.

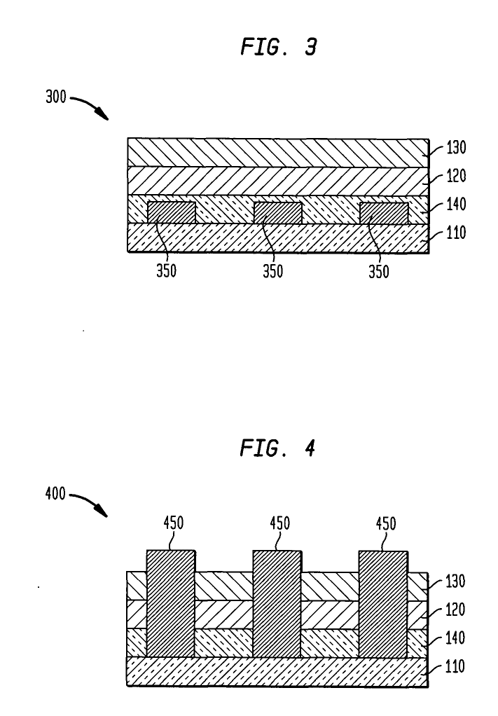

FIGS. 2 and 3 show further cross-sectional illustrations of embodiments 200 and 300, respectively, of electronic microdevices including electrostatic charge dissipation coatings in accordance with the present invention. FIG. 2 shows a cross sectional illustration of an embodiment of a multilayer charge dissipation coating that comprises charged polymer layers 120 and 130, as well as an optional primer layer 140, overlaying dielectric substrate 110. The electronic microdevice shown in FIG. 2 further includes portions of electrical circuitry 250 set apart by a distance 260 of, for example, about 2 micrometers (μm). The electrical circuitry 250 may, for example, be part of an electronic control circuit or may be constituted by electrostatic field—inducing control elements for other device features in the vicinity of such control elements. Where the electrodes 250 are part of an electronic circuit, the multilayer charge dissipation coating removes static charge that could otherwise accumulate in the adjacent dielectric substrate. Where the electrodes 250 are electrostatic field—inducing control elements, the electrostatic field passes through the multilayer charge dissipation coating to control other device features as desired. FIG. 2 illustrates that such electrodes 250 may be incorporated into electronic microdevice 200 after deposition of the electrostatic charge dissipation coatings 120 and 130 according to the present invention.

FIG. 3 illustrates another embodiment of an electronic microdevice 300 including an electrostatic charge dissipation coating in accordance with the present invention. The electronic microdevice shown in FIG. 3 includes electrodes 350, which are in direct contact with dielectric substrate 110 and therefore were incorporated into the electronic microdevice 300 before deposition of the optional primer layer 140 and the electrostatic charge dissipation coatings 120 and 130.

FIG. 4 illustrates another embodiment of an electronic microdevice 400 including an electrostatic charge dissipation coating in accordance with the present invention. The electronic microdevice shown in FIG. 4 includes electrodes 450, which are in direct contact with dielectric substrate 110 and extend through and above the optional primer layer 140 and the electrostatic charge dissipation coatings 120 and 130. Hence, primer layer 140 and electrostatic charge dissipation coatings 120 and 130 are continuous coatings on dielectric substrate 110 except as they are interrupted by electrodes 450. The resulting multilayer coating is self-aligned over the dielectric portions of the electronic microdevice, being the portions not overlaid by the electrodes. In order to fabricate such an electronic microdevice 400, appropriate surface primer chemistry is employed to prepare the desired portions of the exposed surface of the dielectric substrate 110 for application of primer layer 140 or electrostatic charge dissipation coating layer 120. For example, portions of the dielectric substrate 110 overlaid with gold electrodes can be passivated by immersing the dielectric substrate 110 in a solution of an alkylthiol such as octylthiol. A suitable protocol involves exposure to a 1% by weight solution of octylthiol in cyclohexylcyclohexane for 30 minutes at room temperature. The thiol monolayer that is bound to the gold prevents its later reaction with the polymers for preparation of electrostatic charge dissipation primer layer 140 or coating layers 120 and 130. In this way, electrostatic charge dissipation coating layers can be selectively deposited where they are needed over the dielectric substrate 110.

As clear from FIGS. 2, 3 and 4, the placement of the electrodes on the dielectric substrate with respect to the placement of the electrostatic charge dissipation coatings and, if present, the primer layer, are a matter of choice depending on the desired end use application. For example, where the electrodes are to be formed by deposition of a metallized layer which is then etched into the desired circuitry, positioning of the electrodes before deposition of the electrostatic charge dissipation coatings is desirable to avoid exposing such coatings to the etchant.

Referring again to FIG. 1, additional electrostatic charge dissipation coating layers 150 and 160 may be added, respectively carrying charges of the same signs as do electrostatic charge dissipation coating layers 120 and 130. This operation may be repeated as many times as desired, so that the final device has any desired number of pairs of layers 150 and 160, which carry charges of alternating signs. The total combined number of layers 150 plus the number of layers 160 may be an even or odd number. The number of such coating layers 150 and 160 to be applied to a suitable dielectric substrate 110 for a particular end-use application depends on the conductivity necessary to dissipate electrostatic charges that would otherwise accumulate in the dielectric substrate 110. The conductivity needed for a particular application is proportional to the actuation voltage that will be applied to the dielectric substrate 110 in operation of the device. This actuation voltage varies with the particular device that is being operated. In one preferred embodiment according to the present invention, at least two sets of electrostatic charge dissipation coatings, including coating layers 120, 130, 150 and 160, are provided in order to result in significant electrostatic charge dissipation conductivity, although coating layers 150 and 160 can alternatively be omitted. Additional sets of electrostatic charge dissipation coatings provide proportionally greater conductivity. The multilayer coatings according to the present invention can withstand electrostatic field strength in the range, for example, of 100 kV/cm.

Provision of excessive pairs of electrostatic charge dissipation coatings 150 and 160 in a microelectronic device may interfere with the operability of the intended electronic circuitry of the device or with fabrication of the device. Excessive conductivity in electrostatic charge dissipation coatings can lead to excessive parasitic dissipation of the electric current intended to flow in electronic circuitry. Parasitic dissipation reduces the power level in the microelectronic device.

Regarding MEMS devices as a specific example of a non-limiting end-use application according to the present invention, two to five pairs of electrostatic charge dissipation coatings typically are effective. In one particular MEMS application, electrodes that overlay the dielectric substrate operate by generating an electrostatic field used to control the movement of mirrors in the vicinity of the electrodes. Excessively thick electrostatic charge dissipation coatings may unduly weaken such an electrostatic field.

The electrostatic charge dissipation coatings 120 and 130 according to the present invention may generally be fabricated from any polymerizable materials that either carry the desired net positive and negative charges or that can be post-treated with reagents that provide such net charges. Additional materials can be included in such coatings, so long as they do not adversely affect the conductivity or retained net positive and negative charge density in the respective electrostatic charge dissipation coatings. The conductivity of such electrostatic charge dissipation coatings desirably is substantially greater than that of the dielectric substrate 110 itself, although preferably also substantially lower than the conductivity of the electronic circuitry in the microelectronic device. The charge density within the positively- and negatively-charged coating layers desirably is balanced. Preferably, the electronically-conductive polymers are water soluble. This can be accomplished either by selecting an electronically-conducting polymer that is derivativized to contain ionic water-solubilizing groups, or by copolymerizing such polymer together with a water-soluble polymer bearing ionic water-solubilizing groups.

Each of electrostatic charge dissipation coating layers 120 and 130 comprises a charged polymer, which can be, for example, a polyelectrolyte, an ionomer, an inter-polyelectrolyte, or their mixture. Polyelectrolytes are polymers that carry a high concentration of either positive or negative or both positive and negative charged groups; and are water-soluble. Inter-polyelectrolyte complexes include a positively-charged polyelectrolyte coupled to a negatively-charged polyelectrolyte; and can be made water soluble by providing one of the components in excess. Ionomers are copolymers that contain both nonionic repeat units, and a small amount of ion-containing repeat units. lonomers can also be considered to be a subclass of polyelectrolytes containing a lower concentration of charged groups, which generally are not water-soluble.

Ionic antistatic agents, in contrast, are not preferred. These ionic agents include, for example, poly(styrenesulfonic acid), and laundry antistatic agents. Ionic antistatic agents absorb moisture to provide an ionic conduction path for electric charges. Their conductivity performance is sensitive to environmental humidity and they may have a limited capacity for facilitating dissipation of electrostatic charges due to their finite imaginary dielectric constant. In contrast, the electronically-conductive polymers employed in accordance with the present invention can stably conduct electricity without any strong dependence on moisture or humidity.

According to preferred embodiments of the present invention, the electrostatic charge dissipation coatings comprise polyelectrolytes. A polyelectrolyte is a polymer that contains charged groups, such as, for example, sulfonate, ammonium, carboxylic, sulfato, sulfonato, phosphato, or phosphonato groups. For example, ammonium groups are positively charged; and carboxylic, sulfato, sulfonato, phosphate, and phosphonato groups are negatively charged. The charged groups may be present in the polyelectrolyte following polymerization. Alternatively, the charged groups may be generated by a post treatment of the polymer. For example, positively-charged groups can be provided by quaternization of amino groups present in a polymer. Electronically-conductive polyelectrolytes conduct electricity by free carriers rather than by ions. For sufficiently thick coatings, this type of conductivity results in a quasi-infinite imaginary dielectric constant far away from the plasma edge thereby strongly excluding electrostatic field penetration at low frequencies. Polyelectrolytes are commercially available; many are used as solution viscosity modifiers, surfactants and antistatic materials.

According to additional preferred embodiments according to the present invention, the positively-charged electrostatic charge dissipation coating layer may comprise poly(diallyldimethylammonium), referred to herein as (PDAM) which is a polyelectrolyte; and the negatively-charged electrostatic charge dissipation coating layer may comprise a polyelectrolyte selected from polythiophenes, polyanilines and polypyrrole. PDAM has superior thermal and radiation stability compared, for example, to styrene and acrylate polymers. In a further preferred embodiment according to the present invention, the negatively-charged electrostatic charge dissipation coating layer may comprise poly(3,4-ethylene dioxythiophene) complexed with poly(styrenesulfonate), referred to herein as (PEDT:PSS). Poly(styrenesulfonate), referred to herein as (PSS), is a polyelectrolyte containing negatively-charged sulfonato groups. Poly(3,4-ethylene dioxythiophene), referred to herein as (PEDT), is an exemplary polythiophene. PEDT:PSS is highly stable to elevated temperatures and aggressive solvents, at least partially attributable to the 3,4-ethylenedioxy substituents. Polymerizable precursor reagents for production of PSS and PEDT are copolymerized in a desired ratio suitable to yield a negative charge density comparable in magnitude to the positive charge density of the PDAM. In one embodiment according to the present invention, there is one positive charge in the PEDT for every four or five negatively-charged sulfonato groups in the PSS. PEDT:PSS can be replaced, for example, by PEDT:poly(acrylate); PEDT:poly(vinylsulfonate); PEDT:poly(vinylsulfate); polypyrrole:PSS; polypyrrole:poly(acrylate); or a sulfonated or phosphonated polythiophene, polyaniline or polypyrrole. PDAM may be replaced, for example, by poly(allylammonium).

Production of the above polymers proceeds in a manner well known to those of skill in the art. Known production methods use reagents in the form of, for example, monomers, oligomers or prepolymers to be polymerized and then applied as a coating. Optimally, they can be further cured after coating. Polythiophenes, polyanilines and polypyrroles can be made, respectively, by oxidative polymerization of substituted or unsubstituted thiophenes, anilines and pyrroles. For example, the chosen reagents can be dispersed in a suitable solvent, together with any needed polymerization aids such as catalysts, in a formulation suitable for polymerization and subsequent coating on a dielectric substrate surface. PEDT:PSS is obtained by persulfate oxidative polymerization of 3,4-ethylenedioxythiophene in the presence of poly(styrenesulfonic acid), and is commercially available from Bayer A G, Werk Leverkusen, 51368 Leverkusen, Germany, under the tradename Baytron P®. The reagent, 3,4-ethylenedioxythiophene is commercially available from Bayer A G under the trade name Baytron®M. Poly(styrenesulfonic acid) is commercially available from Bayer A G under the trade name HAPSS VP AI 4061. PDAM is obtained by the free-radical polymerization of diallylammonium bromide, and is commercially available from Sigma-Aldrich Corporation, 3050 Spruce Street, Saint Louis, Mo. 63103. The following additional polyelectrolytes, which can be used in accordance with the present invention, are available from Sigma-Aldrich Corporation: poly(styrenesulfonate, sodium salt); poly(diallylammonium chloride); poly(vinylsulfonate, ammonium salt); poly(anetholesulfonic acid); poly(glutamic acid); and poly(quaternium-2).

Preferably, a primer coating layer 140 is applied to the dielectric substrate 110 before application of the electrostatic charge dissipation coating layer 120. The purpose of such a primer layer 140 is to provide a charged surface that is suitable for electrostatic bonding of an oppositely charged layer of an electrostatic charge dissipation coating, and which primer layer 140 is itself firmly bonded to the dielectric substrate 110 or to electrodes overlaying such dielectric substrate. The bonding formed between the primer layer 140 and dielectric substrate 110 may be, for example, ionic or covalent. In a preferred embodiment according to the present invention, the primer comprises 3-aminopropyl(trimethoxysilane), referred to herein as (APS). For example, APS forms covalent bonds with a silicon dioxide dielectric substrate 110, leaving unbound, exposed amino groups. Such amino groups can be quarternized, forming a positively-charged surface suitable for deposition and electrostatic bonding of a negatively-charged electrostatic charge dissipation coating layer 120. Other suitable silanes and other silicon-containing compounds having functional groups capable of rendering a positive charge to the resulting primer layer 140, such as other aminoalkylsilanes for example, can be used.

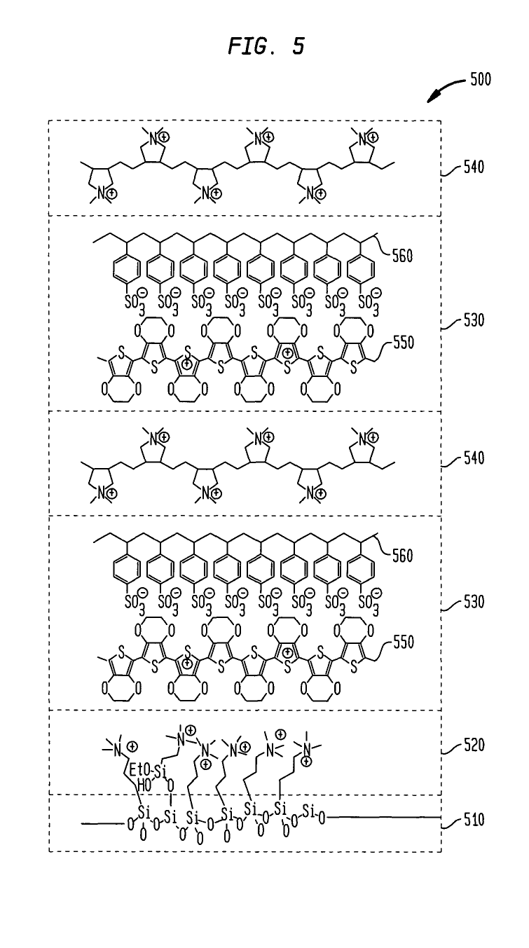

In another preferred embodiment according to the present invention, the primer layer 140 comprises APS, the positively-charged electrostatic charge dissipation coating layer comprises PDAM, and the negatively-charged electrostatic charge dissipation coating layer comprises PEDT:PSS. FIG. 5 illustrates the chemical structure of a multilayer electrostatic charge dissipation coating, constituting an inter-polyclectrolyte coating, prepared from compositions comprising such materials. The inter-polyelectrolyte coating 500 is located on a silicon dioxide dielectric substrate 510. The coating 500 includes a primer layer 520 which is covalently bonded to the dielectric substrate 510, and alternating PEDT:PSS layers 530 and interposed PDAM layers 540, indicated by dotted lines. Although the PEDT 550 and PSS 560 are depicted as being in separate layers, the precursors to these polymers are mixed together so that they form a copolymerized PEDT:PSS layer 530. Although PEDT carries positive charges as shown, the layer 530 overall carries a net negative charge. The PDAM layer 540, on the other hand, carries a net positive charge. As shown in FIG. 5, the electrostatic charge dissipation coating in this exemplary embodiment includes two negatively-charged layers 530, one of which is electrostatically bonded to the positively-charged primer layer 520, as well as two positively-charged electrostatic charge dissipation coating layers 540. The various components of the electrostatic charge dissipation coating are depicted as separate layers in FIG. 5 in order to show their chemical structures. In an actual electrostatic charge dissipation coating, the polymers in mutually adjacent layers interpenetrate, further strengthening the electrostatic and covalent bonds therein.

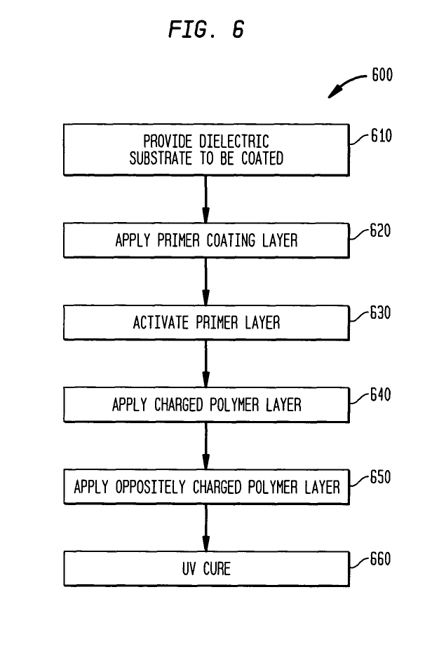

Referring to FIG. 6, an exemplary method 600 is shown for preparing an electrostatic charge dissipation coating according to the present invention that is suitable for use in the electrostatic isolation of a microelectronic device having a dielectric substrate. In this exemplary embodiment, the primer layer 140 comprises APS, the positively-charged electrostatic charge dissipation coating layer comprises PDAM, and the negatively-charged electrostatic charge dissipation coating layer comprises PEDT:PSS. However, it is to be understood that the present invention may be practiced according to the above teachings and using the other materials both as broadly defined and as preferred; and that the methods to be detailed can be easily modified and extended to such materials by persons of skill in the art.

In step 610, a suitable dielectric substrate 110 is provided. For example, the dielectric substrate 110 may be fabricated of silicon dioxide, silicon nitride, or a polymer. Alternatively, another dielectric material may be used. The chemistry of the dielectric substrate composition will dictate the formulation options for the primer layer 140, if used, as desirably the chemical composition of the primer layer 140 is suitable for formation of covalent or ionic bonds with the dielectric substrate 110. As previously explained, any electrodes or electrical circuitry to overlay the dielectric substrate 110 may if desired be directly attached to the dielectric substrate 110.

In step 620, a primer coating layer 140, if desired, is applied to the dielectric substrate 110 as shown in FIG. 1. In an exemplary embodiment according to the present invention, the dielectric substrate 110 comprises silicon dioxide and the primer layer 140 comprises APS. Referring to FIG. 5, the silane groups of the 3-aminopropyl (trimethoxysilane) undergo condensation reactions with the silicon dioxide in the dielectric substrate 110, forming covalent siloxane bonds and leaving the amino groups extending away from the dielectric substrate 110 via the propyl groups.

Referring again to FIG. 6, the APS may be applied, for example, by dipping the dielectric substrate 110 into a solution of APS in a suitable solvent such as toluene. Preferably, such a solution contains about 0.25 weight percent of APS, and the dipping application takes place at a temperature of about 110° C. for between about 10 and 15 minutes. The application is desirably done in a container providing a dry environment in which the moisture content is kept very low, typically less than 0.3% relative humidity, in order to prevent undesired reaction between the APS and moisture. Excess, unbound APS may then be removed from the dielectric substrate 110 having the attached primer layer 140, by washing the dielectric substrate 110 in a series of solvent baths. For example, a series of four toluene or xylene baths can be used. The dielectric substrate 110 may then be suitably dried by removing the remaining solvent. For example, the dielectric substrate 110 can be baked for about ten minutes under an inert atmosphere such as nitrogen at an elevated temperature that is sufficiently low to avoid degradation of the primer layer 140, such as about 120° C.

Alternatively, for example, the dielectric substrate 110 may be subjected to vapor phase deposition of APS at 100° C. for approximately 1 hour. For example, such vapor phase deposition can be carried out as follows. First, the dielectric substrate 110 is cleaned, for example by subjecting the dielectric substrate to an acetone bath with ultrasonic agitation for about five minutes, then an isopropanol bath with ultrasonic agitation for about five minutes, then radio frequency oxygen plasma treatment at 50-100 Watts (W) for about one to three minutes. Next, the dielectric substrate 110 is placed in a vacuum oven set at a temperature between about 30° C. and 150° C., preferably about 100-120° C. The oven is pumped down to a vacuum, typically a pressure of 10⁻² millibars or less. Vapor of the APS primer mixed with an inert gas carrier such as nitrogen, is then introduced into the oven. To obtain such vapor, the inert carrier gas can be bubbled through a column of the APS primer liquid held outside the oven and maintained at a temperature 10° C. below the oven temperature. The bubbled inert carrier gas becomes saturated by the APS primer liquid. The time needed to complete this process is determined by the oven temperature and the gas flow characteristics. After completion of the primer deposition step, the dielectric substrate 110 desirably is subjected to an additional baking step if the primer deposition temperature used was less than 100° C. This baking step may be carried out, for example, by ramping the oven temperature to 120° C. and holding such temperature for 10 minutes. The oven is then pumped down to a vacuum, flushed three times with inert gas, and equilibrated with air to atmospheric pressure. The dielectric substrate 110 can then be removed from the oven.

As a result of the selected dipping or vapor phase deposition step, one or several monomolecular layers of APS are deposited onto the surface of the dielectric substrate 110, yielding a primer coating layer 140 having a thickness of about 8-10 Å, verifiable, for example, using ellipsometry.

In step 630, the primer layer 140 is, if necessary, activated to a charged form. Where the selected primer is APS, for example, the amino groups are activated by their conversion to quarternary ammonium moieties. Such activation of APS can be carried out, for example, by dipping the dielectric substrate 110 into a solution of about 5 weight percent methyl iodide (MI) in dimethylformamide (DMF) at room temperature, the solution also including about 0.1 weight percent of triusopropylamine (TPA) as an acid scavenger. The activated dielectric substrate 110 may then be washed, for example, in a series of DMF baths to eliminate the MI and TPA, washed in isopropyl alcohol (IPA) to exchange the DMF solvent for more volatile IPA solvent, and then dried to remove the IPA under an inert atmosphere such as nitrogen gas.

Alternatively, the primer layer 140 can be omitted. In this case, the initial electrostatic charge dissipation coating layer 120 itself desirably forms covalent or ionic bonds with the dielectric substrate. Alternatively, some form of adhesive bonding may be used.

Referring to FIG. 6, the exemplary dielectric substrate 110 is now ready for application of a first electrostatic charge dissipation coating layer 120 at step 640. This electrostatic charge dissipation coating layer 120 is chosen to carry a charge having a sign opposite to that of the activated primer coating layer 140 applied at steps 620 and 630, so that the electrostatic charge dissipation coating layer 120 applied at step 640 is electrostatically attracted to such activated primer coating layer 140. Alternatively, if no primer coating layer 140 is applied, then the initial electrostatic charge dissipation coating layer 120 applied at step 640 may carry either a net positive or negative charge.

Application of the charged polymer layer 120 at step 640 may be carried out, for example, by dissolving the chosen polymer including the polyelectrolyte in a suitable solvent. The polymer in solution can then be applied to the activated primer layer 140, for example by dipping the dielectric substrate 110 in the solution for about 90 seconds or by spraying the solution onto the dielectric substrate. Desirably, the majority of the solution volume constitutes solvent, so that the polymer is in dilute solution. In this manner, a relatively thin layer of such polymer can be applied to the dielectric substrate 110.

Electrostatic attraction between the charged moieties of the charged polymer and the oppositely charged moieties of the primer layer 140 then electrostatically binds an ultrathin layer of such charged polymer to the primer layer 140. Reagents in the thin layer of charged polymer as applied onto the activated primer layer 140 on the dielectric substrate 110 are only electrostatically attracted to the activated primer layer 140 if they are within the ultrathin portion of such thin layer of such charged polymer that is directly adjacent to such activated primer layer 140. Moreover, further deposition of charged polymer onto the activated primer layer 140 would lead to electrochemically disfavored buildup of excessive unbalanced charge density, resulting in electrostatic repulsion. Hence, the thin layer of charged polymer, except for the ultrathin portion that is electrostatically bound to the activated primer coating 140, can then be removed by washing the dielectric substrate with a suitable solvent and then drying the dielectric substrate in an inert atmosphere. A series of solvent baths, for example, may be used. The resulting ultrathin charged polymer coating will have a uniform thickness. The self-limiting aspect of this process allows for the charged polymer coatings to cover the entire surface of the dielectric substrate 1 10 in a uniform manner. This aspect of the method shown in FIG. 6 is especially advantageous when dielectric substrates 110 contain microelectronic devices with varied structural attributes. The self-limiting process allows the coatings to conform to all such devices regardless of the height of a given device or the depth of any trenches associated with the device.

Since electrostatic attraction between the charged moieties of the primer layer 140 and charged moieties in the charged polymer applied in step 640 yields electrostatic charge dissipation coating layer 120, the strength of such electrostatic attraction can be used to control the thickness of electrostatic charge dissipation coating layer 120. The strength of the electrostatic attractive force is proportional to the density of charged moieties in activated primer layer 140. Hence, lowering the effective density, thickness or activation of primer layer 140 results in reduced electrostatic attraction and correspondingly reduced thickness in electrostatic charge dissipation coating layer 120. The thickness of electrostatic charge dissipation coating layer 120 generally can be controlled in this manner to within a range between about 10 Å to 100 Å. The established thickness of electrostatic charge dissipation coating layer 120, corresponding to a defined charge density, then dictates the thickness of subsequently deposited electrostatic charge dissipation coating layer 130 and any further such layers then added.

Referring to FIG. 6, the exemplary dielectric substrate is now ready for application of a second electrostatic charge dissipation coating layer 130 at step 650. This second electrostatic charge dissipation coating layer 130 is chosen to carry a net charge having a sign opposite to that of the first electrostatic charge dissipation coating layer 120 applied at step 640, so that the second electrostatic charge dissipation coating layer 130 applied at step 650 is electrostatically attracted to the first electrostatic charge dissipation coating layer 120.

Application of the reagents for producing the charged polymer layer 130 at step 650 may be carried out in the same manner as is application of the reagents forming the polymer layer 120 at step 640. Accordingly, an ultrathin layer of such reagents including the selected charged polymer is bound to charged polymer layer 120, and the excess can be removed by washing and drying in the same manner as described in connection with step 640.

In another embodiment, each of steps 640 and 650 may involve application of more than one coating having charges of the same sign, so long as the cumulative charge density of the coatings deposited in each such step is no more than that tolerable in deposition of a unitary coating. For example, in an embodiment in which each of electrostatic charge dissipation coating layers 120 and 130 can have a total thickness of 10 Å to 100 Å, multiple coatings having a cumulative thickness within such thickness range, composed of the same or different charged materials, can be applied.

In one preferred embodiment according to the present invention, the desired primer layer 140 comprises APS, the positively-charged electrostatic charge dissipation coating layer comprises polyelectrolyte PDAM, and the negatively-charged electrostatic charge dissipation coating layer comprises polyelectrolyte PEDT:PSS. Production of an exemplary activated primer layer 140 comprising APS on a suitable dielectric substrate 110 has already been discussed.

Referring to FIG. 6, a first electrostatic charge dissipation coating layer 120 comprising PEDT:PSS is then applied to activated primer layer 140 at step 640. For example, the dielectric substrate containing primer layer 140 may be dipped for approximately 90 seconds into a 5.8 weight percent aqueous solution of PEDT:PSS reagents at room temperature. Unbound PEDT:PSS reagents are then removed by suitable washing and drying. For example, the dielectric substrate may be washed in a bath of deionized (DI) water for about 40 seconds, then washed again in a DI water bath for 20 seconds, rinsed with a DI water spray for 10 seconds, and dried by flushing with nitrogen for 30 seconds.

Referring to FIG. 6, a second electrostatic charge dissipation coating layer 130 comprising PDAM is then applied to PEDT:PSS layer 120 at step 650. For example, the dielectric substrate may be dipped for 130 seconds into a 1.3 weight percent aqueous solution of PDAM reagents at room temperature. Unbound PDAM reagents are then removed by suitable washing and drying. For example, the dielectric substrate may be washed and dried in the same manner as indicated for the preceding step 640.

As indicated in FIG. 1 and discussed above, any desired number of sets of electrostatic charge dissipation coating layers 150 and 160 of chosen polymer compositions may overlay initial electrostatic charge dissipation coating layers 120 and 130. Such electrostatic charge dissipation coating layers may be prepared by alternately repeating steps 640 and 650 for a corresponding number of times.

For example, about seven sets of electrostatic charge dissipation coating layers 150 and 160 may overlay initial electrostatic charge dissipation coating layers 120 and 130 to yield a total coating thickness of about 100 Å. Electrostatic charge dissipation coatings were made in such a manner to generate data exemplifying the invention as detailed below, in the exemplary preparation of MEMS devices. Lesser multilayer coating thicknesses of, for example, between about 20 Å and about 100 Å, can be produced if desired. Furthermore, greater multilayer coating thicknesses as great as, for example, 1,000 Å or more, can be produced if desired.

In some exemplary preferred embodiments for preparation of a MEMS device, the dielectric substrates 110 contained a plurality of overlaid electrodes. The primer layer 140 comprised APS, the positively-charged electrostatic charge dissipation coating layer 120 comprised PDAM, and the negatively-charged electrostatic charge dissipation coating layer 130 comprised PEDT:PSS.

The bulk conductivity of PEDT:PSS coatings is about 1 Siemens (S) per centimeter (S/cm), which is too high for preparation of an electrostatic charge dissipation coating for a MEMS device. In contrast, the conductivity of exemplary dielectric materials in Siemens is less than about 10⁻¹⁵ S/cm; and the conductivity of metals is greater than about 10⁵ S/cm. Therefore, in the exemplary embodiments that were fabricated, the electrostatic charge dissipation coating layers accordingly were exposed in step 660 as shown in FIG. 6 to curing by ultraviolet light (UV). This UV exposure stabilized and lowered the conductivity of the PEDT:PSS coating layers 130 and 160 by one to two orders of magnitude. Prior to the UV exposure, the dielectric substrate 110 was first placed in a quartz tube and flushed with nitrogen for approximately 1 hour. The flushing removed all oxygen, thereby protecting the polymer coating layers 120, 130, 150 and 160 from subsequent photooxidation. The dielectric substrate 110 was then exposed to UV for about one to two hours, in a Rayonet reactor at a temperature ranging from 30° C. to 40° C. The exposure used a low pressure mercury lamp having a wavelength of 254 nanometers (nm) and a radiation density of 5 milliwatts/cm². The 254 nm wavelength coincided with the first absorption band of the phenyl rings in the PSS. The inventors currently believe that such UV exposure leads to dedoping, bond conjugation removal and crosslinking, which reduces the coating conductivity as desired.

For the exemplary MEMS end-use application, the electrostatic charge dissipation coating preferably provides a controlled conductivity across the inter-electrode gap, which is for example about 2 μm, of 10⁻¹¹ to 10⁻⁹ S to avoid large parasitic power losses. Design rules for the sheet resistivity of the electrostatic charge dissipation coating in any given end-use application need to take into consideration the maximum permissible static power dissipation, and the breakdown field strength of the coating. For an electrostatic charge dissipation coating that provides a conductivity of 10⁻⁹ S across adjacent electrode elements, a 100-V bias leaks 100 nanoamperes (nA), which corresponds to a power dissipation of 10 microwatts (μW) per electrode. If the electrode gap is 2 μm—wide and 1 mm—long, then the sheet resistance required is of the order of 500 gigaOhms per square. A bias of 100 V across a 2 μm wide gap corresponds to a field strength of 500 kV/cm. In general for other end-use applications, the conductivity of the electrostatic charge dissipation coatings according to the present invention can be controlled to a chosen point within a range between 0.01 and 100,000 gigaOhms per square for thicknesses between 20 and a few thousand Å.

The exemplary coated dielectric substrates were otherwise prepared in accordance with the above discussion in connection with FIG. 6. The electrical properties of the resulting coated dielectric substrates 110 having a multilayer coating comprising APS primer layer 140, positively-charged PDAM layer 120, and negatively-charged PEDT:PSS layer 130, were tested by measuring the low-field DC conductivity (σ_{low-E}) of the dielectric substrates 1 10. Data were recorded at electrode shield biases of 1, 3 and 10 V, respectively corresponding to 5, 15 and 50 kV/cm, across one row of the electrodes on the dielectric substrates. Typically, 10-12 measurements were taken for each data point to check for the spread across the data and possible systemic effects. The measurements were done in a dry box, so that the true electronic conductivity rather than the ionic conductivity was measured. The σ_{low-E} data were stable and were not subjected to bum-in effects, unlike data regarding high-field conductivity.

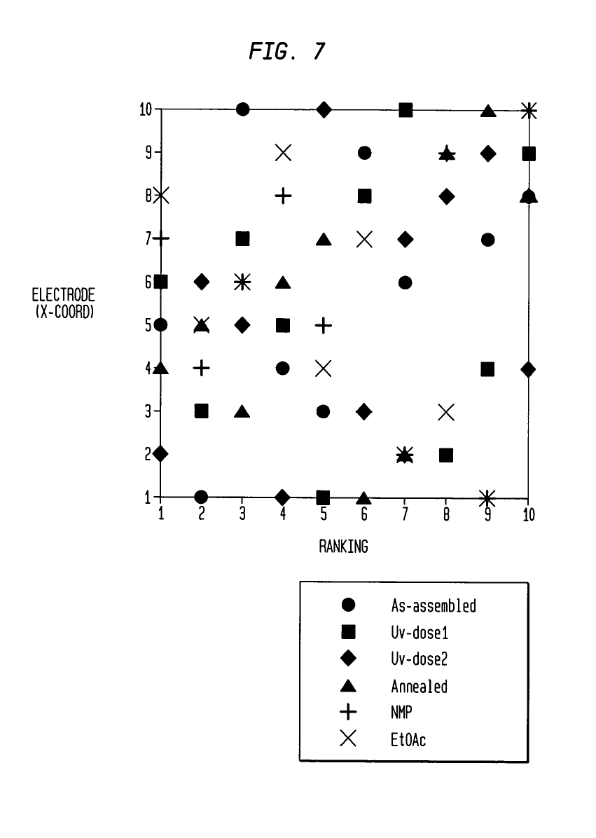

As a result of analyzing the data, no systemic variation in σ_{low-E} was found across the surface of the dielectric substrate. This result is clearly shown in FIG. 7 by the scatter plot of the column number positions of the electrodes, 1-10, against the ranking of the DC conductivity of each electrode at 10 V. Here, 1 is the lowest ranking and 10 is the highest. Plots were taken after different phases of the process for making the coated dielectric substrate 110. The completed coatings applied to the dielectric substrate 110 before UV irradiation are entitled “As-assembled”; after 1 hour of exposure to UV at a wavelength of about 254 nm at a dose of 5 milliwatts/cm² are entitled “UV-dose 1”; after 2 hours UV exposure at the same dose are entitled “UV-dose 2”; after annealing at 220° C. in nitrogen for 30 minutes are entitled “Annealed”; after dipping in N-methylpyrrolidone (NMP) at 55° C. for 10 minutes are entitled “NMP”; and after dipping in ethyl acetate at 60° C. for 10 minutes are entitled “EtOAc”. The purpose of the annealing, NMP exposure, and EtOAc exposure steps was to simulate relatively harsh post-processing conditions to which the coated dielectric substrate might be subjected in the production of a completed microelectronic device such as a MEMS device.

The data appear to be randomly distributed, indicating no systemic correlation of the respective electrode positions with conductivity. This result is in line with the nature of the coating process and confirms that the coating process occurs homogeneously across the dielectric substrate surface. Therefore good scalability to large dielectric substrate sizes can be expected.

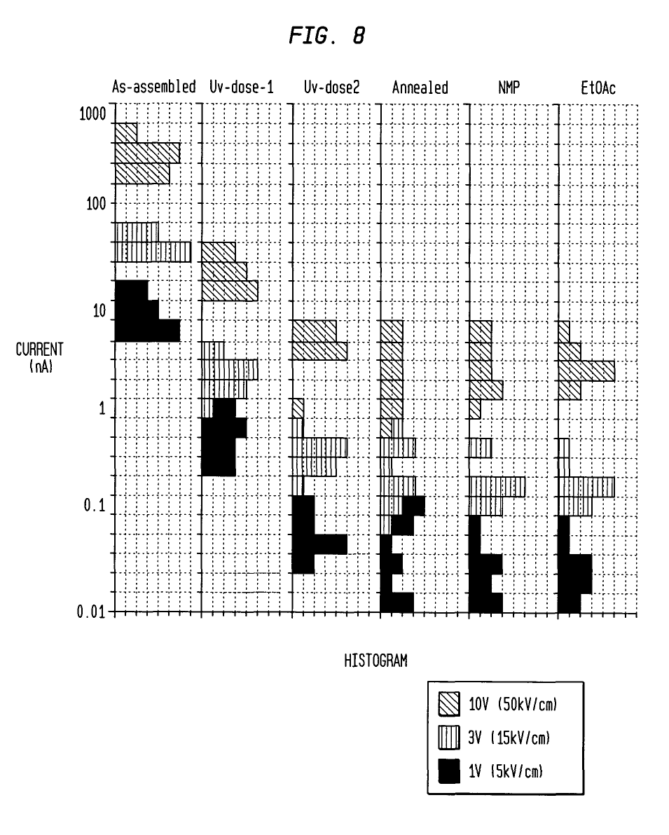

Another property of the coatings and the fabrication process according to the present invention is the tunability of the conductivity, for example by UV curing, while maintaining a narrow conductivity variation. The σ_{low-E} data presented above were pooled together and plotted as histograms as shown in FIG. 8. The vertical axis gives the current values for an electrode-shield bias of 2 μm at 1 V, 3 V or 10 V, respectively corresponding to 5 kV/cm, 15 kV/cm, and 50 kV/cm. Since the order of magnitude of σ is the primary concern, the current axis is displayed on the logarithmic scale with 5 divisions per decade. One decade is one power of ten. Each division therefore corresponds to a multiplication factor of 1.6. The horizontal axis specifies the frequency of occurrence, corresponding to the number of times the particular conductivity value was measured. This plot was used to monitor the changes in the coatings, (i) after assembly of the multilayer coating on the dielectric substrate and after (ii) 1 hour or (iii) 2 hours of UV irradiation at a wavelength of about 254 nm at 5 milliWatts/cm². This plot also was used to monitor the sensitivity of the coatings to the same exemplary aggressive conditions typically involved in subsequent processing of dielectric substrates as discussed with reference to FIG. 7.

The histogram width for the data for electrode-shield biases at 1 V, 3 V and 10 V typically spans only two of the rectangular bins defining the horizontal length of the graphed data elements, referring to the fourth column entitled “Annealed” in FIG. 8. The number of bins in each horizontal graphical data element represents the number of times a measurement of the associated current was observed. Therefore the spread in DC conductivity is 0.4 decades or equivalently, a relative spread of two to three decades. The initial σ_{50 kV/cm} value for the as-assembled coating, shown in the first column of FIG. 8, is 4×10⁻⁸ S, corresponding to a sheet resistivity of 10 gigaOhms per square for the eight pairs of coating layers that were present. Increasing the number of polyelectrolyte multilayers by a factor of ten would produce a sheet resistivity down to 0.1-0.01 gigaOhms per square. Furthermore, with better control of the assembly conditions, the spread was reduced to 1 bin, for example, a relative spread of less than 1.6, in a subsequent dielectric substrate. This result further attests to the uniform coverage that is possible with the assembly process according to the present invention. Control of the process under manufacturing conditions should reduce this spread even further. However, for the purpose of adequate electrostatic charge dissipation, such further reduction is not necessary.

Thus, UV exposure in a nitrogen atmosphere can reduce a relatively high initial conductivity of the coated dielectric substrate by two orders of magnitude to a sheet resistivity of 1,000 gigaOhms per square without increasing the relative spread of DC resistivities. This reduction of the conductivity can be seen in columns 2 and 3 of FIG. 8. Controlling the conditions of the UV treatment allowed control of the final conductivity of the coating. Additionally, the UV treatment was found to arrest the slow decay of the conductivity of the coating that would otherwise occur at high electric fields. Conductivity decay leads to an undesirable “burn-out” of the coatings.

Solvent resistance and thermal robustness are further advantages of the electrostatic charge dissipation coatings according to the present invention. For example, FIG. 8 further shows the stability of these coatings to simulated processing conditions that were considerably more aggressive than those likely to be encountered post-assembly in the production of a completed MEMS microelectronic device. The post-assembly conditions tested, relevant to an exemplary embodiment in which the electrostatic charge dissipation coatings according to the present invention are used in production of a MEMS device, were: (iv) a 30 minute 220° C. nitrogen bake, referring to the column entitled “Annealed” in FIG. 8; (v) a 10 minute 55° C. NMP dip, referring to the column entitled “NMP” in FIG. 8; and (vi) a 10 minute 60° C. ethyl acetate dip, referring to the column entitled “EtOAc” in FIG. 8. Condition (iv) was tested to simulate curing of a polymer such as a polyimide, for example at about 150-200° C. A polyimide may be employed, for example, in production of a MEMS chip in order to create additional structures between the electrode and mirror chips. Condition (v) was tested because NMP is a typical solvent used for spinning polyimide in the course of production of a MEMS chip device. Condition (vi) was tested because n-butyl acetate, closely related chemically to ethyl acetate, typically is used to develop polyimide photoresists.

Annealing the conductive inter-polyelectrolyte coatings at 220° C. in nitrogen for 30 minutes marginally decreased the mean σ_{low-E}. Such annealing could be extended to 3 hours without adverse effects. The glass transition temperature (Tg) of a polymer denotes the temperature at which it changes from a soft rubbery state for which flow is possible, to a hard glassy state for which flow is impossible. Desirably the subsequent processing temperatures for the coated dielectric substrate 110 are considerably lower than Tg of the polyelectrolyte coating, so that the coating remains robust and does not flow. The glass transition temperature (Tg) of the polyelectrolyte coating typically is between about 300° C. and 400° C. Thus, these coatings had the thermal stability necessary, for example, to withstand baking steps between 150-200° C. This thermal stability arises from the kinetic stability of the interlocked polycation-polyanion layers in the multilayer coating.

Furthermore, PEDT is an unusually stable conductive polymer. Through in situ Fourier transform infrared spectroscopy it has been determined that PEDT in a coating applied to a silicon dioxide substrate can dissipate 3 W of electrical power over 1 square millimeter (mm²) when 30 V and 100 milliamps are applied to the dielectric substrate without any change in its electronic and vibrational signature.

Exposing these coatings to NMP for 10 minutes at 55° C. and to ethyl acetate for 10 minutes at 60° C. resulted in no significant change in the mean Cvalues, σ_{50 kV/cm}=2.5×10⁻¹⁰ S, except for a possible and beneficial narrowing of the DC connectivity spread. These test conditions were more aggressive than those encountered in typical subsequent processing steps for production of microelectronic devices. Therefore the conductive polyelectrolyte coatings are sufficiently stable for anticipated post-assembly microelectronic device manufacturing steps.

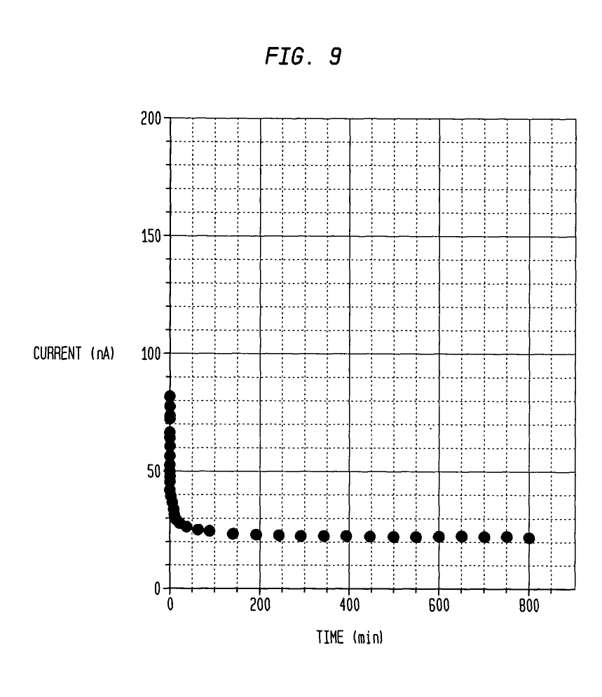

The high-field DC electrical conductivity properties of the coatings are also advantageous. Generally above 50 kV/cm, a slow current decay is found in these coatings within an hour after application of the bias voltage. A bias of 100 V was applied across the space between two electrodes, which may be, for example, about 2 μm. The initial transient current decayed within one to two minutes so that the σ_{500 kV/cm} value settled quickly to stable values, as shown in FIG. 9.

This initial transient current is called the “burn-in” effect, since the DC conductivity values became stable for at least about 13 hours thereafter. The transient effect is speculated to originate from a field-induced relaxation of the polymer chains. Assuming a power-law form for the functional form of the degradation after the initial transient, a log-log plot of data from 100 to 800 minutes can be extrapolated to determine the conductivity half-life. In this way, a half-life is projected for the coating of 10⁷ minutes, greater than 10 years, at room temperature under a 500 kV/cm stress. Moreover, high fields of up to 800 kV/cm can be used without dielectric breakdown, indicating remarkable intrinsic stability of the conductivity of these polymeric ultrathin coatings even under rather large DC fields.

For coatings that have not undergone the UV exposure step, however, “burn out” is often found, in which the coating conductivity drops precipitously by more than 3 to 5 orders of magnitude compared to an open circuit, to less than 10⁻¹³ S, within 1 minute of initiation of the electrical bias.

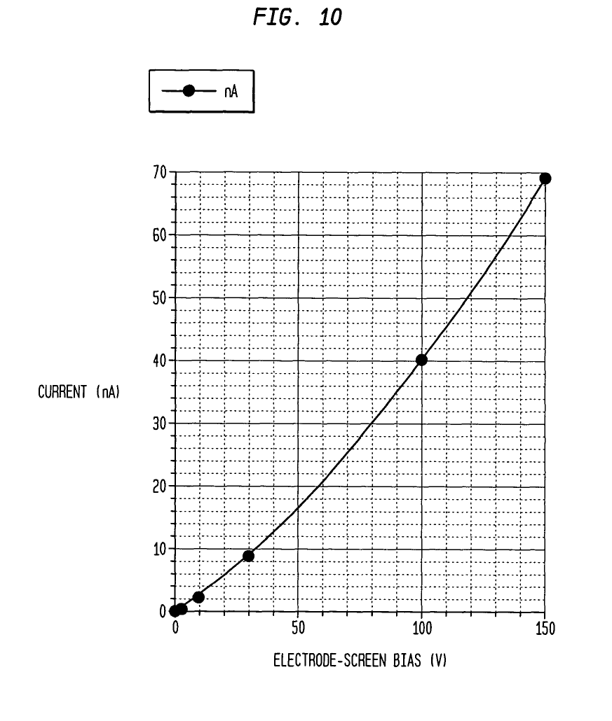

After burn-in, the current minus voltage characteristic of the coatings was nearly ohmic, that is, linear, with a weak positive V dependence. Thus, a bias of 100 V across a 2-μm-wide and approximately 1,000 μm-long gap between the actuation electrode and the ground shield drove a steady-state leakage current of 10-100 nA across the gap. This behavior is shown in FIG. 10 and suggests that percolating conduction paths existed in the coatings. Therefore the leakage resistance was well controlled over a wide range of applied bias voltages. Such behavior is more desirable than that of sub-percolating cermets, which are granular metal films in which the low electrical conductivity is dominated by tunneling and hopping between conductive grains, resulting in exponentially increasing current with an increase in bias.

The electrostatic charge dissipation coatings of the present invention can be incorporated into otherwise conventional devices comprising dielectric materials that accumulate undesired electrostatic charges. For example, the electrostatic charge dissipation coatings of the present invention can be incorporated into MEMS devices. MEMS devices comprise active microdevices such as movable mirrors, microactuators and microsensors, suspended over a dielectric substrate having overlaid electrodes. Voltage applied to the electrodes generates an electrostatic field that can be used in conjunction with conductive elements integrated with the microdevices, in order to control the movement or other operative features of such microdevices. For example, a MEMS device may be fabricated from two subassemblies that are sandwiched together. One subassembly bears the microdevices. The other subassembly bears the dielectric substrate and electrodes. Spacing elements designed to create an operating distance between the electrodes and microdevices are interposed, usually integrated with one of the subassemblies. Prior to sandwiching the subassemblies together, the subassembly bearing the dielectric substrate and electrodes may be provided with an electrostatic charge dissipation coating according to the present invention. The electrostatic charge dissipation coating is suitably grounded so that any unwanted electrostatic charge in the dielectric substrate will be dissipated through the ultrathin coating. Following integration of the subassemblies into a sandwich, the electrostatic charge dissipation coating improves operation of the MEMS device by preventing the accumulation of an electrostatic charge in the dielectric substrate, thereby eliminating unwanted rotation of the active devices such as micromirrors.

Dielectric substrates overlaid with ultrathin charge dissipation coatings according to the present invention may also be used in other microelectronic circuits, other solid state devices, and other devices where there is a need to discharge unwanted electrostatic charges including, for example, other devices comprising dielectric substrates. For example, the following additional types of microelectronic devices can be provided with electrostatic charge dissipation coatings in accordance with the present invention: integrated-circuit capacitive sensors; fingerprint sensors; particulate transporting electrode grids used in xerographic processes; printed resistors for controlled discharge applications; and ink-jet printing heads. Additionally, ultrathin charge dissipation coatings according to the present invention may be applied to provide anti-static protection of memory disks, read-write heads, and clean room work surfaces.

The ultrathin coatings according to the present invention can be designed to have a stable electronic conductivity controlled as desired over a wide range from 0.01 gigaOhms per square to 100,000 gigaOhms per square depending on the end-use application, and can work even at zero relative humidity.

While the present invention has been disclosed in a presently preferred context, it will be recognized that the present teachings may be adapted to a variety of contexts consistent with this disclosure and the claims that follow. For example, although portions of the discussion have been presented in the context of preferred reagents in which the positively-charged electrostatic charge dissipation coating layer comprised PDAM, the negatively-charged electrostatic charge dissipation coating layer comprised PEDT:PSS, and a primer was included comprising APS, it is to be recognized that the other reagents disclosed can also be used. In addition, although portions of the discussion have been presented in the exemplary context of fabrication of MEMS devices, the present invention is broadly applicable to the preparation of electrostatic charge dissipation coatings for dielectric substrates susceptible to the accumulation of an electrostatic charge.

We claim:

1. An apparatus comprising:
a first polymer layer carrying positively charged moieties and a net positive charge;
a second polymer layer carrying negatively charged moieties and a net negative charge; and
a dielectric substrate;
said first and second polymer layers constituting a multilayer coating on said dielectric substrate.

2. The apparatus of claim 1 in which said first polymer layer is in direct contact with said dielectric substrate.

3. The apparatus of claim 1 in which said second polymer layer is in direct contact with said dielectric substrate.

4. The apparatus of claim 1 comprising a primer layer chemically bonded to said dielectric substrate and electrostatically bonded to said multilayer coating.

5. The apparatus of claim 1 comprising:
a third polymer layer carrying positively charged moieties and a net positive charge; and
a fourth polymer layer carrying negatively charged moieties and a net negative charge; said first, second, third and fourth polymer layers being arranged in a multilayer coating having mutually alternating net charges on said dielectric substrate.

6. The apparatus of claim 1, in which at least one of said polymer layers comprises a polyelectrolyte.

7. The apparatus of claim 1, in which said first polymer layer carrying a net positive charge comprises quarternary ammonium groups.

8. The apparatus of claim 1, in which said second polymer layer carrying a net negative charge comprises at least one member selected from the group consisting of carboxylic, sulfato, sulfonato, phosphate, and phosphonato groups.

9. The apparatus of claim 1 in which said multilayer coating has a sheet resistivity between about 0.01 gigaOhms per square and about 100,000 gigaOhms per square.

10. The apparatus of claim 4 in which said primer layer comprises an aminoalkylsilane.

11. The apparatus of claim 6, in which said polyelectrolyte comprises poly(3,4-ethylene dioxythiophene)-poly(styrenesulfonate).

12. The apparatus of claim 7, in which said first polymer layer carrying a net positive charge comprises poly(diallyldimethylammonium).

13. The apparatus of claim 8, in which said second polymer layer carrying a net negative charge comprises at least one member selected from the group consisting of polythiophenes, polyanilines and polypyrroles.

14. A method for fabrication of an electrostatic charge dissipation coating comprising steps of:
providing a dielectric substrate susceptible to electrostatic charge accumulation;
coating said dielectric substrate with a first polymer carrying charged moieties and a net charge having a first sign; and
then coating said dielectric substrate with a second polymer carrying charged moieties and a net charge having a second sign opposite to said first sign.

15. The method of claim 14 further comprising: coating said dielectric substrate with a primer layer before performing the step of coating said dielectric substrate with a first polymer, the primer layer capable of bonding to said dielectric substrate and carrying charged moieties and a net charge of said second sign.

16. The method of claim 14 comprising steps of:
then coating said dielectric substrate with a third polymer carrying charged moieties and a net charge having said first sign; and
then coating said dielectric substrate with a fourth polymer carrying charged moieties and a net charge having said second sign.

17. The method of claim 14 in which one of the steps of coating comprises coating said dielectric substrate with a polyelectrolyte.

18. The method of claim 14, in which one of the steps of coating comprises coating said dielectric substrate with a polymer that comprises amino groups.

19. The method of claim 14 in which one of the steps of coating comprises coating said dielectric substrate with a polymer that comprises groups carrying a negative charge selected from the group consisting of carboxylic, sulfato, sulfonato, phosphate, and phosphonato groups.

20. The method of claim 14 in which one of said steps of coating comprises coating said dielectric substrate with a polymer selected from the group consisting of thiophenes, anilines and pyrroles.

21. The method of claim 14 further comprising the step of curing said coatings by exposing the coated dielectric substrate to ultraviolet light.

22. The method of claim 14 further comprising the step of fabricating a mechanical element having a movable member on said dielectric substrate prior to coating said dielectric substrate with said first polymer.

23. The method of claim 14 further comprising the step of fabricating a mechanical element having a movable member on said dielectric substrate after coating said dielectric substrate with said first polymer.

24. The method of claim 14 comprising, before coating said dielectric substrate with said first polymer, the steps of providing an electrode on said dielectric substrate and passivating a surface of such electrode to inhibit adherence of said first polymer to said surface.

25. The method of claim 15, in which said primer layer comprises an aminoalkylsilane.
